(19) United States
(12) Patent Application Publication
(10) Pub. No.: US 2004/0159974 A1
(43) Pub. Date: Aug. 19, 2004

(54) Method of molding and apparatus

(76) Inventor: Carolyn Anderson Fischer, Stillwater, MN (US)

Correspondence Address: Carolyn A. Fischer, 11068 66th St. N., Stillwater, MN, 55082, US

(21) Appl. No.: 10/368,148

(22) Filed: Feb. 18, 2003

(51) Int. Cl. B29C 33/40

(52) U.S. Cl. 264/219; 425/111

(57) ABSTRACT

The invention relates to a method of molding and apparatus. The method and apparatus utilize a pin assembly comprising a plurality of pins wherein each pin has a fixed x-coordinate position, a fixed y-coordinate position, and is moveable in a z-coordinate position.

### FIELD OF THE INVENTION

The invention relates to a method of molding and apparatus. The method and apparatus utilize a pin assembly comprising a plurality of pins wherein each pin has a fixed x-coordinate position, a fixed y-coordinate position, and is moveable in a z-coordinate position.

### BACKGROUND OF THE INVENTION

Various techniques have been described for making replicas.

U.S. Pat. No. 3,988,520 relates to a three dimensional reproduction of an object made by photographing the object at predetermined intervals by rotating the camera in a fixed plane 180 degrees about a fixed axis which is at right angles to the plane of rotation. Each photograph is divided at a point perpendicular to the photograph and along the axis of rotation. Each photograph is then embedded in or affixed to a wedge shaped carvable material, the angle of the wedges being the same as the angle of rotation between photographs. The wedges are fitted together such that the dissected portions of each photograph meet each other at the common axis in a linear plane, and all wedges, when fitted together, form a 360° circle. The outlines of the photographed article in the composite of wedges represent substantially a three dimensional reproduction of the article. Each wedge, when carved along the outline, represented by the photograph, thus produces a substantially accurate three dimensional reproduction of the image photographed.

U.S. Pat. No. 5,280,305 provides a device that produces a three-dimensional object with custom art work from an electronic signal. More particularly, the preferred implementation is a device for making masquerade-type masks, and includes a digital camera that captures a front-on image of an individual's face and converts the captured image to an electronic signal that is downloaded into a personal computer. The computer is utilized to select an image, process that image to remove background, scale the image to correspond to the dimensions and features of a facial die that will be used to mold the mask, and to provide for special effects processing of the selected image. An ink jet plotter is then directed to print the processed image upon thin, flat plastic, which is aligned with the facial features of the die and deformed to skin tight conformance with the die by a vacuum-forming process. The finished mask bears art work, upon its convex exterior, that realistically imitates the face of the individual which served as the model for the mask.

U.S. Pat. No. 5,363,159 describes a three dimensional photographic technique comprises scanning the outside surface of the three dimensional surface such as a human subject using a color digitizer which generates spatial and color data relating to the outside surface. The spatial data is used to generate a mold having a concave surface corresponding to the outside surface of the subject. A thin hollow shell of transparent plastics material is molded in the mold to define an outer surface of the shell which corresponds to the outer surface of the subject. The photographic material is applied on the inside surface of the hollow shell and is exposed using an image manipulation system and fiber optic transportation system which extracts the light from a screen and transmit it to a position adjacent the outside surface of the hollow shell to provide the required colored image on the photographic material for display through the transparent material of the hollow shell.

U.S. Pat. No. 5,736,201 teaches a process for making a doll's head looking like the head of a living person the process involves rotating the person on a first rotatable support and scanning the rotating head with respect to both topography and color. The scanning output is digitized and fed to a computer with custom software. On a second rotatable support are forming means driven by the computer and used to fashion a partly finished doll's head based on the topography input. The partly finished head is then transferred to a third rotatable support and as it rotates, ink jets also driven by the computer software, colors the doll's head correspondingly.

Although various techniques have been described, industry would find advantage in methods of molding and mold apparatus that allow for practical, low cost production of unique objects.

### SUMMARY OF THE INVENTION

The method of the invention relates to providing a pin assembly comprising a plurality of pins. Each pin comprises a shaft and a pinhead. Each pin has a fixed x-coordinate position, a fixed y-coordinate position, and is movable in a z-coordinate position. The method further comprises varying the z-coordinate position of at least a portion of the pins such that the pinheads form a three-dimensional surface, fixing the z-coordinate position of the pins, and contacting the three-dimensional surface with a molding material.

The pin assembly may be designed such that the pinheads comprise spaces between adjacent pins. In alternative embodiments, the pinheads are planar and the pin assembly is designed such that the pinheads are substantially free of spaces between adjacent pinheads (i.e. closest pins on each side of an individual pin) and thus the pinheads form a substantially continuous surface.

In one aspect of providing a pin assembly wherein the pinheads are substantially free of spaces between adjacent pinheads, the pins comprise a suitable geometric shape such as squares, pentagons, hexagons and octagons. Further, the pinhead typically comprises a diameter that is the same as the shaft of the pins.

In a preferred embodiment, the method further comprises contacting a liner with the pinheads. The liner may be provided prior to varying the z-coordinate position or after varying the z-coordinate position yet prior to contacting the three-dimensional surface with the molding material.

The three-dimensional surface is preferably a replication of at least a portion of a person, animal or objects such as the face portion of a person. The replication is typically scaled to a different (e.g. smaller) size. The varying of the z-coordinate position of pins is preferably in response to a computer readable three-dimensional image.

In another embodiment, the invention relates to a method of making a topographical map comprising providing a pin assembly, each pin having a pinhead, wherein each pin has a fixed x-coordinate position, a fixed y-coordinate position, and is movable in a z-coordinate position, contacting a surface (e.g. of an object or person) with the pin assembly such that the pins move in the z-coordinate position replicating the contacted surface, and recording the x, y and z-coordinates of the pins. The method preferably further comprises scaling the coordinates to a different size.

In another embodiment, the invention relates to a mold derived from any of the methods described herein.

In other embodiments, the invention relates to articles such as dolls, action figures, statues, figurines and headstones derived from any of the methods described herein.

In other embodiments, the invention relates to a molding apparatus comprising a pin assembly comprising a plurality of pins, each pin a shaft and comprising a pinhead, wherein each pin has a fixed x-coordinate position, a fixed y-coordinate position, and is movable in a z-coordinate position such that the pinheads form a three-dimensional configuration. The apparatus comprises at least one or any combinations of features including a means for fixing the three-dimensional configuration of the pins, a liner disposed on the pinhead surface, wherein the pinheads are planar and form a substantially continuous surface, and wherein the pins have a density of at least 125 pins/square inch.

In one aspect, the pin assembly comprises a first plate separated from a second plate by a gap, both plates having a plurality of aligned openings and wherein the shaft of the pin extends through the plates.

In the method of molding and the apparatus of the invention, the liner preferably comprises a shrink-wrap film, a vacuum-formed film, and/or a film comprising a fluoroelastomers.

### BRIEF DESCRIPTION OF THE DRAWINGS

FIG. 1 is a perspective view of an exemplary molding device.

FIG. 2 is a perspective view of an exemplary spherical shaped molding device.

FIG. 3 depicts an enlarged portion of the device of FIG. 2.

FIG. 4 is a planar view of a two-part molding device including a liner.

FIG. 5 depicts a perspective view of the molded liners of FIG. 4 inserted in a conventional injection-molding apparatus.

### DETAILED DESCRIPTION OF THE PREFERRED EMBODIMENTS

The invention relates to methods of molding and apparatus utilizing a device comprising a plurality of pins. The pins are preferably provided in a housing, i.e. a support or framework to hold the pins. As used herein, “pin assembly” refers to a plurality of pins in a housing wherein with respect to a Cartesian coordinate system, each pin has a fixed x-coordinate position, a fixed y-coordinate position, and is movable in the z-coordinate direction. The z-coordinate of each pin is independently positionable to form a desired configuration such as the replication of a three-dimensional surface. The three-dimensional surface comprises at least one cavity, protrusion, or combination thereof.

“Pin” refers to a thin stiff piece of material, such as metal, having a length at least 10 times its diameter. The pin has a shaft. The bottom surface of the shaft is referred to herein as the base of the pin, whereas the opposing surface is the pinhead. In some embodiments, the pinhead has a larger diameter than the shaft. In other embodiments, the pinhead has the same diameter of the shaft and thus comprises the top surface of the shaft. The pins may comprise a variety of geometric shapes. For examples the pins may comprises a cylindrical-shaped shaft with round pinheads. The pins may have other cross-sectional shapes such as squares, hexagons, etc.

The pinheads of the pin assembly contact a liner and/or other molding material. The pinheads are preferably relatively smooth to aid in the removal of the molded liner and/or solidified molding material from the configured pin surface. Accordingly, the heads of the pins are typically planar or slightly curved. The heads of the pins may further comprise a coating (e.g. fluoropolymer) that aids in such removal. Further, various mold release agents as are known in the art may be employed.

The method of the invention comprises providing a pin assembly comprising a plurality of pins wherein each pin has a fixed x-coordinate position, a fixed y-coordinate position, and is movable in the z-coordinate direction. The method further comprises varying the z-coordinate position of at least a portion of the pins forming a three-dimensional surface, preferably fixing the z-coordinate position of the pins, and contacting the three-dimensional surface with a moldable material.

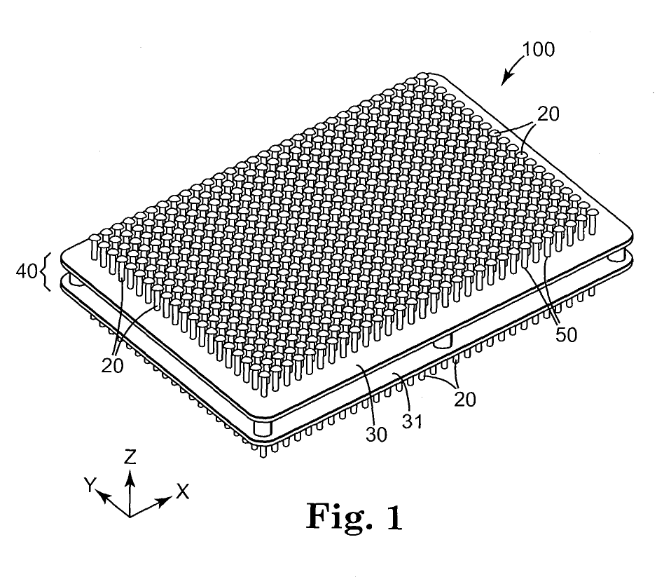

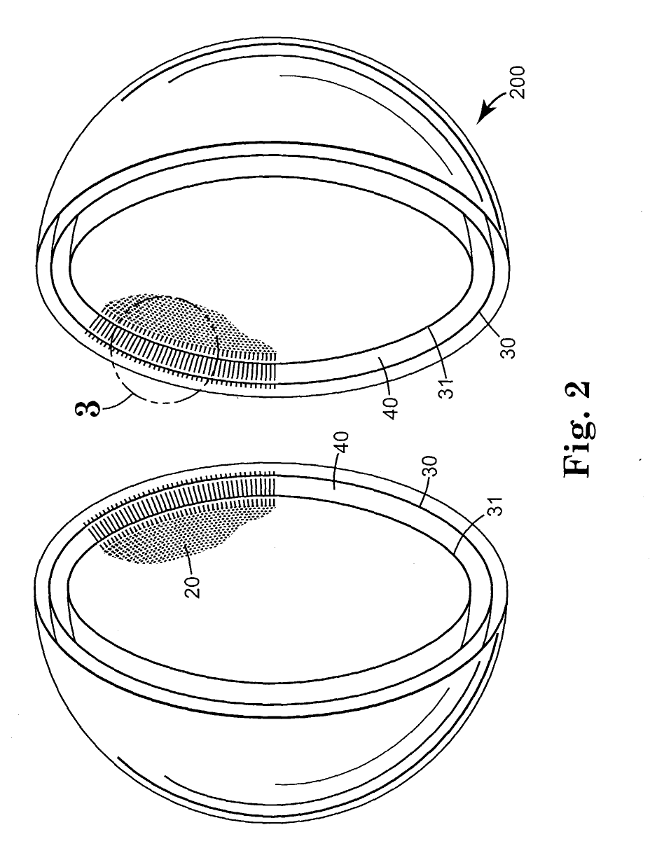

The x-coordinate and y-coordinate of each pin is fixed due to the relative placement of each pin in the pin assembly. For example, with reference to FIG. 1, the pins may be provided such that the pins are assembled in rows and columns. Accordingly, each pin has a x, y-coordinate determined by its position in the row and column. For example, the two pins reference character 20 depicts on the left-hand side of FIG. 1 have Cartesian coordinates x 1, y=13 and x=1, y=17. The fixed coordinates of FIG. 2 can be described in a similar manner by for example viewing the hemispherical cavity in plan view and superimposing a x-axis through the center in one direction and a y-axis through the center in a direction perpendicular to the x-axis.

The pins typically have a common length (i.e. the distance from the base to the pinhead) throughout the pin assembly. Prior to varying the z-coordinate position of the pins, all the pins are typically first positioned such that the pins have the same initial z-coordinate position (e.g. z=0). The length of the pins typically limits the distance of movement of the pins in the z-coordinate direction. Accordingly, the pin length of the pin assembly is chosen based on the anticipated difference between the z-coordinate position of the highest pin and the z-coordinate position of the lowest pin for the articles intended to be molded. The difference between the z-coordinate position of the highest pin and the z-coordinate position of the lowest pin is typically at least 1 mm, such as in the case of replicating the face portion of a 4 inch (10 cm) figurine. For other molded objects, such as the face portion of a 12-inch (30-cm) doll sold by Mattel under the trade designation “Barbie”, the difference is typically at least 2 mm and more typically at least 3 mm. For larger objects, such as the face of an 18 inch or larger doll, the difference between the z-coordinate position of the highest pin and the z-coordinate position of the lowest pin is typically at least 4 mm and more typically at least 5 mm. In the case of figurines wherein the entire figure is molded from the pin assembly the difference between the z-coordinate position of the highest pin and the z-coordinate position of the lowest pin typically ranges from about 1 cm to about 30 cm.

The diameter of the pins and the number of pins per area of the pin assembly will be chosen based on the intended size and detail of the object to be molded (e.g. replicated). In general, the more pins per area, the better the resolution. However, increasing the number of pins per area inversely relates to the diameter of the pins. As the pin diameter diminishes, the strength of the pin as it relates to its ability to withstand the molding process without deforming also diminishes. The diameter of the pins (e.g. shaft and optionally pin head) is preferably less than about 2 mm and more preferably less than 1.5. For even better resolution, the diameter of the pins is preferably about 1 mm and more preferably about 1/2 mm or less. Typically, the pin density, i.e. the number of pins per square inch is at least 100, more preferably at least 125, even more preferably at least 150 and most preferably at least 175 pins per square inch. For even better resolution, the pin density is about 200, preferably about 300 and more preferably about 400 pins per square inch.

In one embodiment, a pin assembly is provided wherein the pinheads comprise spaces between adjacent pinheads. For such embodiments, the spaces between adjacent pins typically range from being about 1/2 of the diameter of the pins to being about equal to the diameter of the pin. However, the spaces may be smaller provided the plate material has sufficient structural integrity.

In one exemplary embodiment, with reference to FIGS. 1-4, the x-coordinate and y-coordinate of the pins may be fixed by means of a pair of plates 30 and 31 separated by a gap 40. Each plate has a plurality of openings 50 slightly larger in diameter than the diameter of the shaft of the pins such that each pin can move freely and independently in the z-coordinate position yet is constrained within the openings by the plates in both the x-coordinate position and y-coordinate position. The openings of plate 30 are aligned with the openings of plate 31 such that the shaft of the pin extends through the plates and the pin is positioned substantially perpendicular to both plates. Although not required, the openings typically have the same shape as the cross-sectional shaft of the pin (e.g. circles, square, etc). A pair of screens may conveniently provide square openings. Typically, the plates are rigid. However, provided that the x-coordinate and y-coordinate position is maintained and the pin can move freely in the z-coordinate direction, flexible plates are also suitable.

The pin assembly preferably, but not necessarily, has one or more means of preventing the pins from moving in the z-coordinate direction beyond plates 30 and 31 in either direction. Such constraint may be provided by the pins having pinheads that are at least slightly larger than the openings of plates 30 and 31 as depicted in FIG. 1-3. The pins may have heads on both opposing ends of the shaft of the pin (i.e. base and pinhead). An alternative means of constraining the movement in z-coordinate direction may be provided by a second pair of plates, i.e. exterior pair of plates. Such exterior plate(s) are continuous at least at the locations of each opening of plates 30 and 31. The second pair of exterior plates are typically parallel to plates 30 and 31 such that one surface (e.g. heads) of the pins are constrained by the first exterior plate and the opposing surface (e.g. base) of the pins is constrained by the second exterior plate. Further combinations of exterior plate portions and portions wherein the pinheads are slightly larger than the opening may be employed on the same surface or employed on opposing surface. For example, the surface of the pin assembly above and parallel to plate 30 may have an exterior plate in combination with the pinheads being slightly larger than the openings of plate 30 or vice-versa. Prior to varying the pins in the z-coordinate direction, the pins are initially positioned against one plate or one surface of pinheads such that the pins have the ability to move substantially the entire length of the pin in the z-coordinate position except for the distance between plates 30 and 31.

A pin assembly similar to the pin assembly depicted in FIG. 1 is commercially available from Games by James (Maplewood, Minn.) under the trade designation “Pin Art”. Pin Art further comprises a transparent plastic plate on the exterior that is parallel to plates 30 and 31 and above plate 30. Accordingly, the heads of the pin are constrained by the transparent plate in one z-coordinate direction and constrained by the backside of the pinheads contacting plate 30 in the opposing z-coordinate direction. The overall dimension (i.e. of the parallel plates) of Pin Art, with reference to FIG. 1, is 7 inches in the x-coordinate direction by 5 inches in the y-coordinate direction. The portion comprising the pins is about 7 inches in the x-coordinate direction by 4 inches in the y-coordinate direction. The gap between the top transparent cover sheet and plate 30 is about 1⅛ inches. Further, the gap between plate 30 and plate 31 is about 3/8 inches. Plates 30 and 31 are made of a rigid opaque black plastic material. The pins appear to be made of metal. The length of the pins is about 1⅞ inches. The pinheads have a diameter of about 3/32 of an inch. The shaft of the pins has a diameter of slightly less than 1/16 of an inch with the openings in the plates being about 1/16 of an inch. The spacing between openings in the plates is about 1/8 inches in the y-coordinate direction and about 1/16 of an inch in the x-coordinate direction. The pin density in planar view is 105 pins per square inch. In FIG. 1 the pins are arranged in parallel rows, each row sharing a common x-coordinate in the x-coordinate direction and a common y-coordinate in the y-coordinate direction. However, in the case of Pin Art the openings in the plates and the pins are provided such that every other row is offset by about ½ of the distance of the space between openings relative to the adjacent rows.

The commercially available Pin Art is suitable for use in the method of the invention. However, since Pin Art was not intended for use as a molding device, various improvements of this device, as described herein, are preferred in order to improve this basic design for use in high speed molding processes such as die casting and various plastic molding techniques.

In an alternative embodiment, a pin assembly is provided wherein the pinheads form a substantially continuous three-dimensional surface. Accordingly, the pinheads are substantially free of spaces between adjacent pinheads.

In one aspect, a continuous pinheads surface may be provided by modifying the embodiments depicted in FIG. 1-4 such that the pinheads having a suitably larger diameter than the cross-section of the shaft of the pin such that the pinheads overlap to some extent with the adjacent pin heads. In such embodiment, the pinhead is preferably connected to the shaft by means of a bearing (e.g. ball) such that the pinhead can rotate about the shaft as well as pivot. Accordingly, rather than the pinhead having a single z-coordinate position, the z-coordinate position can be slightly different on one edge of the pinhead relative to the opposing edge due to the ability of the pinhead to tilt at an angle. This aspect is advantageous for smoothing the surface between adjacent pins having significantly different z-coordinate positions. It is also preferred that the pinheads comprise a minimal height (e.g. less than 0.5 mm). Further, it is preferred that the pins are positioned in the z-coordinate direction in a sequential random manner so the overlapped portions are evenly distributed.

As yet another means of providing a pin assembly wherein the pinheads form a substantially continuous three-dimensional surface, it is surmised to modify the embodiments depicted in FIG. 1-4 by incorporating hollow (e.g. plastic or metal) pin sleeves over the pin shaft. After varying the z-coordinate position, the diameter of the plastic sleeve may then be expanded with any suitable means such as heat and/or compressed air to form a continuous surface portion. This action will concurrently fill the spaces between pins as well as fix the pins in the configured z-coordinate position.

In yet another embodiment, a substantially continuous three-dimensional surface is provided by employing pins comprising a suitable precisely machined geometric shape (i.e. shaft as well as the surfaces) such that each surface of the shaft of one pin contacts the shaft of adjacent pins. The pins are generally provided such that the pinheads (e.g. molding surface) and the base of the pins comprise substantially the same diameter as the shaft of the pin. Suitable geometric shapes include squares, pentagons, hexagons, octagons etc. For example, each of the shaft surfaces of a square shaped pin contacts a shaft surface of four adjacent pins, whereas each of the shaft surfaces of a hexagon shaped pin contacts the shaft surfaces of six adjacent pins. Due to the precisely machined geometric shape the spaces between pins is negligible, typically being within machining tolerances (e.g. diamond tooling machine tolerances). Accordingly in this embodiment, the pin assembly generally lacks the separations of the pin shafts provided by the openings of plates 30 and 31 as depicted in FIG. 1-4. Rather, the assembly of pins is typically provided in a frame-like housing that spans the perimeter of the pin assembly. The x-coordinate and y-coordinate of the pins is determined by its position within the assembly. The pin assembly is typically positioned such that gravity holds the pins in their initial z-coordinate position. For example, the pin assembly may be placed on a piston assembly wherein each pin has a corresponding piston beneath the pin. Initially the frame-like housing has sufficient slack such that each pin can be moved to the desired z-coordinate position to form the intended surface configuration. After positioning, the frame-like housing is then tightened to fix the z-coordinate positions of the pins in place. Such a mold have structured rather than planar pinheads is described in U.S. Pat. No. 1,591,572, and U.S. Pat. No. 3,926,402 reissued as Re. 29,396 that relates to a pin for making a reflector.

Regardless of whether the pin assembly is provided with spaces between the pins or in a manner such that the molding surface is substantially continuous, the method of the invention comprises varying the z-coordinate position of the pins, i.e. to make at least a portion of the z-coordinate position of the pins different from one another. The z-coordinate position can be manually varied such as by pressing a surface of an object into the bed of pins causing the pins to move in the z-coordinate direction in correspondence with the contacted surface of the object. Manually varying the pins in this manner is particularly suitable for the manufacture of replicas of existing objects wherein the molded object is intended to be the same size as the object, person, face portion, etc. Alternatively, the depth (i.e. z-coordinate) of a person or object can be measured at various locations, such locations being chosen to correspond to certain x, y-coordinates of the pins. Each pin of the pin assembly may then be manually adjusted to the desired position with a measuring device.

Smaller sized replicas are generally desirable for molding various statues, toys (e.g. dolls, action figures), and figurines that are replicas of individual persons, animals, objects, etc. For embodiments wherein the molded object is intended to be a different size (e.g. smaller) it is preferred that the pins are advanced and/or retracted by automated means such as various mechanical, electrical, and pneumatic means as are known in the art. For example, each pin may be equipped with or comprise a piston that can advance or retract the pinheads of the pin assembly to the desired z-coordinate position. Accordingly, the piston and pin may be one in the same. Further, it is preferred that the z-coordinate position be varied in response to a computer readable three-dimensional image. The objects to be molded may be custom designed with for example a computer-automated design (CAD) system, as are known in the art. Alternatively, the molded object may be a replication of at least a portion of a person, animal, or object derived from a three-dimensional imaging technique (e.g. three-dimensional photograph).

Various techniques have been described for creation of three-dimensional photographs such as described in U.S. Pat. Nos. 5,898,438; 5,363,159; and 4,238,148; incorporated herein by reference. Such techniques may employ scanning devices or digital cameras that form a three-dimensional image by computer fitting of multiple two-dimensional images taken at various angles. Such imaging techniques preferably include colorimetry measurements in order to, for example, match the color of the molding material with the skin tone of a person or for paint selection in order to match skin tone, eye color, etc. in subsequent painting techniques. If the object to be molded is for dental (e.g. tooth, denture) or medical uses (e.g. replacement joints, disks), more sophisticated imaging techniques including nuclear-magnetic resonance, cat scans and ultrasound may be used to create the computer readable three-dimensional image.

Such three-dimensional photographs can be taken at a remote location. For techniques that employ commercially available digital cameras, the three-dimensional photographs may be taken at home. Regardless of the point of origin, such three-dimensional photographs may be sent electronically to a manufacturing site. In other embodiments the three-dimensional imaging technique and molding device may be incorporated into a single device.

In yet another embodiment, a pin assembly may be employed to form a topographical map. For this embodiment, a surface of an object or person (e.g. face portion), etc. is contacted with the surface of the pin assembly such as by pressing the surface into the bed of pins. This causes the pins contacting the surface of the object or person to move in the z-coordinate position in a configuration that is a replica of the contacted surface. The depressed or elevated depth of each pin may then be recorded such as by manually measuring the depth of each pin. Preferably each pin is equipped with an electronic sensor suitable for detecting and signaling the depth of each pin in order to electronically map the surface. The data points of the coordinates (i.e. x, y and z) may then be scaled smaller or larger to a different size as desired. Suitable mathematical scaling techniques are commonly known in the art. This may be accomplish with a separate pin assembly or integrated into the same pin assembly as employed for molding.

After varying the z-coordinate position of the pins by any suitable means in the desired configuration, the pins are then fixed for receipt of a molding material. It is preferred to fix the z-coordinate position with a suitable automated means such as an opposing force provided by a piston for increased manufacturing efficiency. In doing so the pins can easily be released from their fixed position and repositioned momentarily thereafter into a different configuration for the purpose of making a different object. However, for home crafts uses for example the pins may be fixed by simply pressing the base of the pins into a pliable material such as a piece of molding compound that corresponds to the dimensions of the pin assembly.

The pin assembly may have any suitable geometric design. In one embodiment, as depicted in FIG. 1, the pins 20 of a pin assembly molding device 100 are provided in a common plane at least throughout the dimensions of the molded surface portion and optionally throughout the dimensions of the entire molding device. With reference to FIG. 1, the molding device may comprise a single plane of movable pins. Such pin assembly design is suitable for molding objects having a single molded surface such as for example plaques, picture frames, and the like.

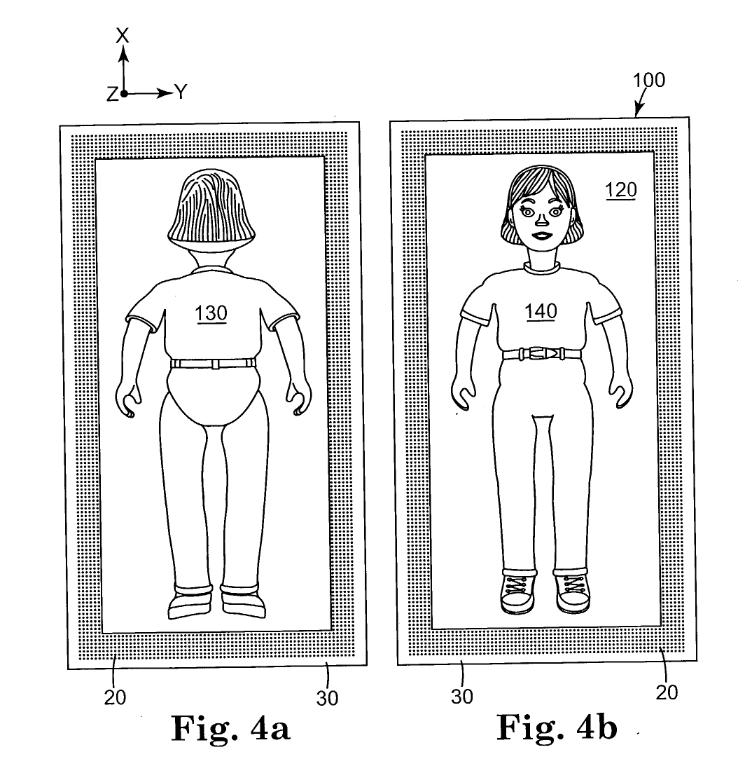

For three-dimensional objects wherein more than one surface is molded, a two-part mold is typically employed. With reference to FIGS. 4a and 4b, a two-part mold may comprise a pair of planar pin assemblies, each pin assembly having the same general design as pin assembly 100 of FIG. 1. In other embodiments, more than two planar pin assemblies may be provided in the shape of for example a triangle, square or rectangle.

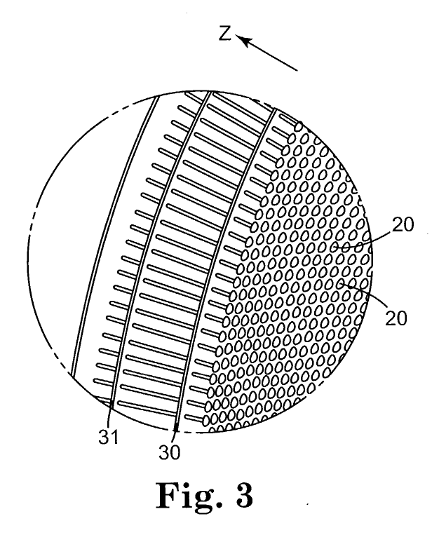

In another embodiment, as depicted in FIG. 2, a two-part mold 200 wherein each part is hemispherical in shape may be employed. As depicted in FIG. 3, although the pins are not coplanar throughout the dimensions of the mold, each individual pin is provided in substantially the same plane as the adjacent pins. Typically, the radius of curvature of the plates between adjacent pins is small in view of the pin assembly having a relatively high pin density. Spherical shaped pin assemblies are surmised preferred assembly designs for molding spherical (e.g. hollow) shaped objects such as doll heads with for example blow molding techniques. Planar shaped pin assemblies and well as curved pin assemblies (e.g. hemispherical, shapes between a plane and a hemisphere) are surmised preferred for molding face portions In the embodiments depicted in FIG. 1-3, the molding surface of the pin assembly is discontinuous, having small spaces between each individual pinhead and the adjacent pinheads. The presence of such gaps is surmised unproblematic for certain molding techniques, certain molding materials, and certain objects wherein the technique or molding material is insensitive to flowing into such gaps. For example thermoforming (i.e. with sheets of film), blowing molding or the use of semi-viscous molding materials may be suitable. Alternatively, surface defects caused by such gaps can be removed with subsequent finishing steps. For example, plaster, porcelain, and composite filled resinous materials may be surface abraded (e.g. sanded) to remove surface defects, whereas plastic molded objects can be surface finished with techniques that include heat.

In another embodiment, the method and apparatus of the invention further comprises a liner. For example with reference to FIGS. 4a and 4b, a figurine may first be depressed into the surface of the pin assembly. In further detail, the back half of the figurine may be depressed into pin assembly 100 of 4a and the front half of the figurine into the pin assembly of 4b. After the z-coordinate position of the pins is fixed, liner 120 contacts the configured surface portion of the assembled pins and thus the liner replicates the configured surface of the molding device. Accordingly, a first cavity 130 corresponding to the back side of the figurine is provided in the liner of FIG. 4a and a second cavity 140 corresponding to the front side of the figurine is provided in the liner of FIG. 4b.

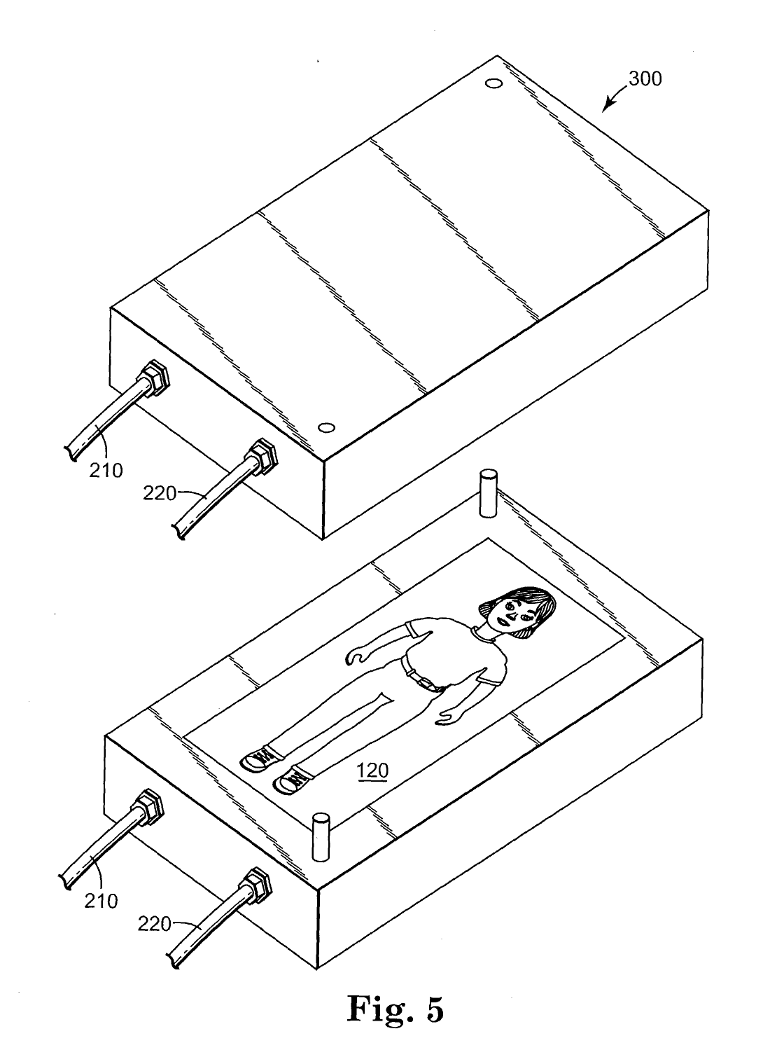

The liner thus formed may be freestanding and sufficiently strong such that the liner itself may be employed as a mold or mold insert for a conventional molding device. For example the liners may be employed as inserts in a two-part injection mold 300 as depicted in FIG. 5 to mold the figurine object. Alternatively, the liner may be relatively weak such that it deforms when contacted with the molding material. In such embodiments, the configured movable pin device, other materials (e.g. sand, molding compound), or an opposing force (e.g. compressed air, water) may support the liner. For example, in the case of injection molding, the liner (e.g. metal) may be provided as an insert in a conventional plastic injection mold 300 as depicted in FIG. 5. The opposing surface of the insert may then be cooled with circulating water provided by inlet hoses 210 and outlet house 220. The circulating water may have the dual function of both cooling the molded liner insert as well as preventing deformation of the molded surface of the insert.

Typically, the liner is continuous. Continuous liners are particularly preferred for use in combination with pin assemblies wherein the pinheads comprise spaces between pinheads. The presence of the liner is of particular importance for use of the pin assembly with low viscosity molding materials that have a tendency to flow into the spaces between pinheads. The presence of the liner also forms an angled surface between adjacent pinheads smoothing the surface between pins of significantly different z-coordinate positions. In an alternative embodiment, the liner may be discontinuous and primarily provided to smooth the surface between pinheads or fills the spaces between pinheads on the configured surface.

The thickness of the liner generally ranges from about 10 microns for liner coatings to about ½ inch or greater for molding cement. Typically, however, the liners have a thickness of less than 10 mils, preferably less than 5 mils, and more preferably less than about 2 mils.

Depending on the liner material, the liner may be provided prior to or after the pins are positioned in the desired configuration. For example, liner materials having the ability to stretch to accommodate the movement of the pins may be disposed on the pin assembly prior to configuring the surface. Liner materials having sufficient elastic recovery may be used repeatedly and/or made integral with the pin assembly apparatus. The liner material may be removable from the molded object such as in the case when employed as a mold or mold insert. Alternatively, and particularly in the case of employing thermoplastic liners in combination with thermoplastic molding materials, the liner may become integral with the surface of the molded object.

The liner can be made of a variety of materials and will be chosen based on the intended molding material and intended molding technique. In the case of molding techniques that employ molten thermoplastic resins, metal foils and fluororelastomers are typically preferred liner materials. Alternatively, thermoplastic materials having a higher melt temperature than the molding material may be employed. Thermoplastic liners may be provided as a preformed sheet or film that is vacuum-formed or shrink-wrapped to the configured pin assembly device. Further, the liner may be cast as a molten film directly onto the (e.g. configured) pin assembly. In doing so, it is preferred to apply the molten thermoplastic material with a non-contact method wherein the thermoplastic material cools to sufficiently build viscosity prior to contacting the configured pin assembly. One and two-part curable compositions such as radiation curable compositions as well as foamed liner materials are also surmised suitable.

In the case of cement, plaster of Paris, and other non-thermoplastic molding materials, other liner materials in addition to those already described are suitable liner materials such as paper (e.g. moistened) as well as various woven and non-woven fabrics. In yet other aspects, particularly wherein the spaces between pinheads are relatively small various polymeric materials may be provided in aqueous or solvent-based solutions, emulsion, or dispersions (e.g. hair spray) to provide a coating sufficient for filling the voids between pinheads. Various combinations of liner materials may also be employed. For example, a porous liner material (e.g. paper) may be employed in combination with a coating that functions as a water barrier. Such liner materials are surmised to be particularly suitable for home craft uses.

The pins may be comprised of any suitable material depending on the intended molding material choice and the intended molding process variables (e.g. heat, pressure). Suitable pin materials for various thermoplastics molding techniques include high temperature plastics (e.g. polycarbonate, acrylic), metals (e.g. stainless steel, nickel, copper), ceramics, and composite materials. Other lower melting point plastics as well as wood may be suitable for the molding of non-thermoplastic materials such as plaster. For embodiments wherein the pin assembly comprises plates (e.g. 30 and 31), the plates that fix the pins in the x-coordinate and y-coordinate position may be made of the same material as the pins or of a different material. The pins and plates are built such that the openings about each pin as well as the pins can bear the load exerted upon the pin without deforming the plates or pins.

The molding apparatus comprising the pin assembly having the plurality of pins is useful in a variety of molding techniques and with a variety of molding materials. The molding apparatus preferably comprises a means for fixing the three-dimensional configuration of the pins and/or a liner and/or pins with planar pinheads in combination with the pinheads forming a substantially continuous surface and/or a pen density of at least 125 pins/square inch.

In general, the molding material is flowable such that it conforms to the mold surface and subsequently solidifies. Various molding techniques are known depending on the selection of material to be molded. Suitable molding materials include various metals (e.g. copper, aluminum, brass, silver), cement, glass, ceramic, plaster of Paris, paper mache, porcelain, wax, as well as various thermoplastic polymeric resins, thermosetting polymeric resins and composite materials that typically comprises high concentration of (e.g. decorative) inorganic materials in a resin matrix. Many food items may also be molded including cakes, candy (e.g. hard candy, chocolate), cookies, crackers, cereal, gelatin, frozen dessert products (e.g. ice cream bars), etc.

Thermoplastic resins are capable of being repeatedly softened by heat and hardened by cooling. Commonly employed thermoplastic resin for plastic molding include styrene polymers and copolymers, polyethylene's (e.g. low density polyethylene LDPE and high density polyethylene HDPE), polypropylene, vinyl's (e.g. PVC) and to a lesser extent nylons and acrylics. Thermosets are materials that are initially thermoplastic yet undergo a chemical curing reaction through the application of at least one variable such as heat, catalysts, ultraviolet light, etc., leading to a non-thermoplastic state or at least substantial increase in melt temperature. Typical thermosets include aminos (melamine and urea), most polyesters, alkyds, epoxies, and phenolics. Additives such as fillers, plasticizers, reinforcements, modifiers, pigments, etc. are often used in making plastic products.

The mold and/or liner of the invention is ideally suited for adaptation to existing low cost plastic molding process such as injection molding, blow molding, rotational molding, and thermoforming.

Thermoplastic injection molding processes generally include injecting a liquid resin (either as a hot, molten thermoplastic, or a thermoset that is still in liquid form) into a closed mold, under pressure, until the part has cooled or cured and can be ejected from the mold. In a typical process, the plastic injection plasticizing cylinder, also referred to as the extruder, consists of a barrel with heater bands outside and a rotating screw inside. The resin, in pellet form, feeds from the hopper into the heated barrel where shear forces, friction and the heat from the heater bands melts the plastic. The heater bands also keeps the melted resin (“melt”) at a constant temperature inside the barrel. Depending on the resin, this temperature can be between approximately 300° F. and 590° F. (150° C. and 310° C.). As it turns, the screw can move axially back and fourth. This allows the melt to accumulate in the front of the barrel as the screw retracts away from the front of the barrel. When the portion of melted resin (i.e. shot) is delivered, the screw moves forward forcing the melted resin into the cavity. The screw is constantly turning to keep the resin melted and to plasticize additional material as the shot is delivered. Even after the cavity is completely filled, the screw continues to push forward to maintain the pressure in the cavity as the melt cools. Once the shot is complete and the plastic freezes off in the mold, the screw begins to retract (“recover”) to accumulate the next shot of melt. The size of the barrel, the horsepower of the screw drive motor and other factors determine the speed of recovery and thus how many shots can be delivered in an hour. For high speed production, the injection molding machine includes a “fast recovery” injection molding system that may involve an accumulator which is a separate heated barrel using a system of valves, the accumulator takes up the melted resin like a syringe and allows the extruder to begin its recovery earlier while the accumulator delivers the shot and maintains the pressure as the part cools.

Blow molding is widely used process for the production of hollow thermoplastic shapes such as plastic bottles and containers. The process is divided into two general categories: extrusion blow molding and injection blow molding. In extrusion blow molding, a tube of plastic material is dropped or lowered from an extruder. Mold halves close around the tube, which is then expanded against the cavity wall by the injection of air. Injection blow molding involves a two-stage process where plastic is first injection molded into a preform. The preform is then transferred to a blow mold where it is expanded.

In rotational molding, at least one and typically several molds may be placed on the machine at the same time. Pre-measured plastic resin is loaded into each mold, and then the molds are moved into the oven where they are slowly rotated on both the vertical and horizontal axis. The melting resin sticks to the hot mold and coats every surface evenly. The mold continues to rotate during the cooling cycle so the parts retain an even wall thickness. Once the parts are cooled, they are released from the mold. The rotational speed, heating and cooling times are all controlled throughout the process.

Thermoforming involves the process of heating a thermoplastic sheet to a working temperature and then forming it into a finished shape by means of heat or pressure.

In the method of molding at least a portion of an object is molded with the method described herein. Likewise, at least a portion of the molding apparatus comprises or is derived from the pin assembly. The method and apparatus is suitable for making a wide variety objects, provided the resolution of the molding device (i.e. number of pins per surface area) is sufficient for the intended detail of the object. The method and apparatus may be used in the manufacture of an entire object (e.g. figurine) or only a portion thereof such as the face portion or the head portion of a doll or figurine. The molded objects or portion thereof may be solid or hollow.

In one preferred embodiment, a portion of the molded object (e.g. doll) may employ the method and/or apparatus described herein with the remainder of the molded object being molded from a conventional mold. It is particularly preferred that at least the face portion be replicated by use of the method and/or apparatus described herein. For example, if one desired to make a doll head by means of blow molding, one could employ a conventional blow mold replacing only the face portion with the pin assembly or liner made therefrom.

The overall dimensions (e.g. length and width, circumference) of the movable pin assembly will range depending on the intended objects to be molded. For example a two-part mold, each having a molding surface of about 1 square inch (5 cm²) may be employed examples for doll faces or candy, whereas a two-part mold having an overall dimension of approximately 1 foot in width by about 3 feet in height may be employed for garden statues. In the case of making full sized replica of individual people, groups of people (e.g. couple, family), animals, or when more than one object will be concurrently molded from the same pin assembly, the pin assembly may be considerably larger.

The method of molding and molding apparatus may be employed for conventional molding techniques for the purpose of making a mold, making a mold insert or for manufacturing a high volume of molded article. However, the invention is particularly suitable for custom molding of decorative parts and objects wherein molds with high machining tolerances are not required. Further, the invention is ideally suitable for making low-cost objects that are replicas of people, animals or faces wherein the object is molded entirely or at least the face portion molded from the pin assembly. Illustrative molded objects include for example dolls (e.g. entire dolls, head, or face portion), custom-fit masks, action figures, statues (e.g. garden), and various figurines such as birthday dolls, decorations for cakes (graduation, wedding, birthday), trophy figurines.

In some embodiments, the object comprises a molded surface portion in combination with an unmolded surface (e.g. planar) wherein the molded surface is formed from the pin assembly of from a liner made therefrom. For example, the object may comprise a three-dimensional protrusion on one surface with the other surface being substantially planar. Illustrative articles of manufacture include decorative plaques, confectioneries (e.g. hard candy, chocolates), holiday decorations (e.g. Christmas ornaments), molded headstones, frames for pictures and mirrors; decorative hardward for motorcycles and cars, molding for houses (e.g. home restoration of molding not commercially available), cabinet hardware, etc. Such molded articles just described may also comprise additional molded surfaces as well.

In other embodiments, the object will be molded on at least two surfaces and typically on the entire outer surface. Illustrative but non-limiting list of parts and objects include cabinet hardware, legs for furniture, various medical uses such as replacement joints, dentures, etc.

Some of the molded articles described herein may be manufactured with a craft kit that comprises a pin assembly, optional liner material, and molding material (e.g. paper mache, plaster of Paris. The pin density of the pin assembly of the kit is typically at least about 100 and preferably at least about 150 pins per square inch.

Once the object has been molded it may be finished by a variety of other processes as are known in the art. As previously mentioned, surface defects can be corrected with various techniques depending on the molding material. Figurines and action figures for example will typically be painted by hand or painted with computer assisted means. In the case of dolls, hair-styling, facial details (e.g. freckles) etc. may be added such as described on the web site http://www.mytwinn.com/.

It is to be understood that the above description is intended to be illustrative. Various modifications and alternations of this invention will become apparent to those skilled in the art form the foregoing description without departing form the scope and spirit of the invention, and it should be understood that this invention is not unduly limited to the illustrative embodiments set forth herein. The invention will further be illustrated by the forthcoming non-limiting example.

### EXAMPLE 1

A pin assembly apparatus purchased from Games by James (Maplewood, Minn.) under the trade designation “Pin Art” was disassembled and reassembled without the transparent cover sheet. Care was taken such that the pins remained in their original x-coordinate and y-coordinate positions. After removal of the transparent cover sheet, the apparatus has the same appearance as FIG. 1. A rectangular piece of modeling compound commercially available from Rose Art under the trade designation “Fun Dough” having a thickness of about ¾ of an inch and dimensions of about 7 inches in the x-coordinate direction by about 4 in the y-coordinate direction was placed on top of a piece of clear plastic wrap distributed by Supervalu Inc, Eden Prairie, Minn. under the trade designation “HomeBest”. The pin assembly (without the cover) was placed on top of the piece of modeling compound such that the base of the pins contacting the modeling compound causing the pins to elevate upwards by the thickness of the modeling compound. A face of a small birdhouse of a birdhouse wind chime was replicated using the pin assembly. The face of the birdhouse was pentagonal shaped being approximately 3½ inches at its maximum width and about 4⅛ inches at its maximum height. Three of the peripheral edges of the face of the birdhouse had rectangular shaped protrusions having a width of about 1/4 inch and a depth of about ¼ inches that formed the peripheral edges of the roof and the base. The face of the birdhouse was contacted with the upwardly facing surface portion of the pin assembly (i.e. surface having pin heads) and pressed downward in the center portion of the pin assembly to a depth of about ½ inch. A cavity was formed that replicated the surface of the small birdhouse. A piece of the clear plastic wrap was employed as a liner. The clear plastic wrap was placed on the surface of the pin assembly. The back of a plastic spoon was used to push the clear plastic wrap into the 1/4 inch width protrusions. Plaster of Paris was prepared according to the manufacture's instructions by mixing ½ cup plaster of Paris with ¼ cup of cold water. The cavity comprising the liner was then filled with the prepared plaster of Paris. The plaster of Paris was allowed to solidify for 45 minutes. The plastic wrap liner along with the molded birdhouse was removed from the pin assembly. The plastic wrap was then removed from the molded object. The molded object was a replication of the face of the birdhouse except for surface defects that were caused by wrinkling of the plastic wrap. Such surface defects may be eliminated by the use of a liner material that can conform to the liner without wrinkling such as shrink-wrap or vacuum-formed plastic films or by coating the pin head surface with a coating that is insoluble in water yet removable from the pin head surface.

What is claimed is:

1. A method of molding an article comprising
providing a pin assembly comprising a plurality of pins, each pin comprising a shaft and a pinhead, wherein each pin has a fixed x-coordinate position, a fixed y-coordinate position, and is movable in a z-coordinate position;
varying the z-coordinate position of at least a portion of the pins such that the pinheads form a three-dimensional surface;
fixing the z-coordinate position of the pins;
contacting the three-dimensional surface with a molding material.

2. The method of claim 1 wherein the pinheads comprise spaces between pinheads.

3. The method of claim 1 wherein the pinheads are planar and form a substantially continuous three-dimensional surface.

4. The method of claim 3 wherein the pins comprise a shape selected from squares, pentagons, hexagons and octagons.

5. The method of claim 4 wherein the pinhead comprises a diameter that is the same as the shaft of the pins.

6. The method of claim 1 wherein the method further comprises contacting a liner with the pinheads.

7. The method of claim 6 wherein the liner is selected from shrink-wrap films, vacuum formed films, and films comprising fluoroelastomers.

8. The method of claim 6 wherein the liner is provided prior to varying the z-coordinate position.

9. The method of claim 6 wherein the liner is provided prior to contacting the three-dimensional surface with the molding material.

10. The method of claim 1 wherein the three-dimensional surface is a replication of at least at least a portion of a person, animal or object.

11. The method of claim 10 wherein the three-dimensional surface is a replication of face portion of a person.

12. The method of claim 10 wherein the replication is scaled to a different size.

13. The method of claim 1 wherein varying the z-coordinate position of pins is in response to a computer readable three-dimensional image.

14. A mold derived from the method of claim 1.

15. A mold derived from the method of claim 6.

16. An article selected from the group comprising dolls, action figures, statues, figurines, and headstones wherein a least a portion thereof is molded by the method of claim 1.

17. A method of making a topographical map comprising:
providing a pin assembly, each pin having a pinhead, wherein each pin has a fixed x-coordinate position, a fixed y-coordinate position, and is movable in a z-coordinate position;
contacting a surface of an object or person with the pin assembly such that the pins move in the z-coordinate position replicating the contacted surface; and
recording the x, y and z coordinates of the pins.

18. The method of claim 17 further comprising scaling the coordinates to a different size.

19. A molding apparatus comprising:
a pin assembly comprising a plurality of pins, each pin a shaft and comprising a pinhead, wherein each pin has a fixed x-coordinate position, a fixed y-coordinate position, and is movable in a z-coordinate position such that the pinheads form a three-dimensional configuration; and wherein the apparatus comprises at least one or any combinations of features selected from the group comprising:
a) a means for fixing the three-dimensional configuration of the pins;
b) a liner disposed on the pinhead surface;
c) wherein the pinheads are planar and form a substantially continuous surface; and
d) wherein the pins have a density of at least 125 pins/square inch.

20. The molding apparatus of claim 19 wherein the pin assembly comprises a first plate separated from a second plate by a gap, both plates having a plurality of aligned openings and wherein the shaft of the pin extends through the plates.

21. The molding apparatus of claim 19 wherein the liner is selected from shrink-wrap films, vacuum formed films, and films comprising fluoroelastomers.
